(19) United States
(12) Patent Application Publication
(10) Pub. No.: US 2017/0301034 A1
(43) Pub. Date: Oct. 19, 2017

(54) Method And System For Combatting Tax Identity Fraud

(71) Applicant: Paul J. Golasz, Anniston, AL (US)

(72) Inventor: Paul J. Golasz, Anniston, AL (US)

(21) Appl. No.: 15/483,070

(22) Filed: Apr. 10, 2017

Related U.S. Application Data
(60) Provisional application No. 62/390,899, filed on Apr. 13, 2016.

(51) Int. Cl. G06Q 40/00; G06Q 50/26

(52) U.S. Cl. CPC G06Q 40/123; G06Q 50/265

(57) ABSTRACT

Disclosed is a method for combatting tax refund fraud, which functions in combination with a taxpayer's social security number (SSN) and a random, electronically-generated Anti-Fraud Identity Authentication Number (AFIN). The AFIN is generated, assigned, and mailed annually to each citizen. The AFIN may be utilized by federal, state, and foreign income tax agencies, and with either paper or e-filed tax returns. The AFIN is included in an electronic process of combining with the taxpayer's SSN, to produce an “AFIN/SSN,” which information is then stored in a secure master database. The tax agency scans each return upon receipt comparing the submitted AFIN/SSN to the AFIN/SSN database. If the scanned AFIN/SSN on the return matches the AFIN/SSN database, the system automatically allows the tax filing transaction to proceed to completion. If there is a mismatch with the AFIN/SSN database, the return is earmarked and becomes subject to further tax agency scrutiny.

### CROSS-REFERENCES TO RELATED APPLICATIONS

This patent application claims the benefit of priority from previously-filed U.S. provisional patent application Ser. No. 62/390,899, filed on Apr. 13, 2016, and claims the benefit of content of said provisional application as though fully appearing herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The present inventive concept relates to fraud prevention. More particularly, in the preferred embodiment, the following inventive concept discloses a system and method for providing secure transactions and preventing fraud with respect to the filing of an individual's income tax return with the Internal Revenue Service (IRS) of the United States, individual states, and tax agencies of foreign countries. Other embodiments of the inventive concept also apply to foreign governments and their taxing agencies or authorities. Further, the disclosures relate to combating criminal identity theft as a means of their procuring fraudulent income tax refunds which have caused the theft of billions of taxpayer dollars, both at the United States federal and state levels.

### (2) Description of the Related Art, Including Information Disclosed Under 37 CFR 1.97 and 1.98.

The following references have some similar features in comparison to the present inventive concept.

U.S. Pat. No. 8,150,747 B2 (Nov. 23, 2005; Neher, et al); A tax return preparation kit is provided that contains a disposable tax return preparation device for receiving taxpayer input of tax related data for use in preparing an electronic tax return. The disposable tax return preparation device is adapted to prepare an electronic tax return based on the tax related data. A communications cable is also provided for communicatively coupling the disposable tax return preparation device to a telecommunications system, for transmitting the electronic tax return to a remote tax return preparation system also coupled to the telecommunications system. The remote tax return preparation system is adapted to receive the tax return prepared by the disposable tax return preparation device, confirm the tax return, and electronically file the tax return with a tax authority.

U.S. Pat. No. 8,355,935 B2 (Aug. 31, 2010; Hellman, et al); A method allowing a professional service provider to access client data stored in an online account without storing confidential account information by the professional service provider. In particular, the service provider may register the relationship with the client in a third party information transfer framework where the client approves such registration and download the data from the online account using the confidential account information in a temporary manner. The client data may be stored in a repository available to the service provider based on the relationship registration. In an example, a professional tax preparation software may include functionality to check for newly downloaded client data within the third party information transfer framework, notifying a tax accountant (i.e., the service provider), and may provide a one click access to import the client data directly into the client tax return.

U.S. Published Patent Application #2008/0115198 A1 (Oct. 31, 2006; Hsu, et al); A system that uses multi-factor authentication while retrieving information is described. During operation, the system requests and receives multiple authentication factors from a user of an application on a first host. These multiple authentication factors are associated with a document on a second host, and include authentication information that enables access to the document. Furthermore, the system uses the multiple authentication factors to access the document. While accessing the document, the system retrieves information from the document by navigating through the document, identifying the information, and aggregating the information.

U.S. Published Patent Application #2007/0271221 A1 (May 16, 2007; Gephart, et al); Systems and methods tor securing a social security number involve pairing a traditional personal identification number, or other personal identifier, with a social security number for verification purposes. In particular, the owner of the social security number can link a PIN, or other identifier, to their social security number in a data storage system. If the owner of a social security number is required to verify their identity, the institution requiring the identity verification can request from the user and submit the person's PIN, or other personal information, to a third-party granting system (e.g., trusted entity), in order to verity that it is paired with the social security number. If the PIN matches the social security number/PIN pairing in the data storage system, the institution can be notified that the individual is verified, and/or indeed owns the social security number.

U.S. Published Patent Application #2002/0019938 A1 (Aug. 3, 2001; Aarons); Described is an apparatus for containment of Digital Personal Identity Signatures for use in completing and signing documents in a network or internet environment. The apparatus contains a digital signature certificate issued by a third party that is used in place of an actual signature to allow completion of binding contracts through the use of a computer used over an internet or Intranet environment. The apparatus includes a custom designed Compact Disc containing encrypted data and software that is used to access the digital signature in a secure environment. Access to the data is provided in a secure environment by requiring the use of an access password or Personal Identification Number, an alphabetic pass phrase or, an alphanumeric pass phrase to prevent fraudulent use of the digital signature in the event of loss or theft of the apparatus.

### SUMMARY OF HISTORICAL BACKGROUND

1. Early History

During the past several years, the Internal Revenue Service (IRS) of the United States has urged American taxpayers to file their income tax forms electronically and arrange for refunds to be directly deposited into their bank accounts. This electronic filing, or “e-filing,” is appealing because it provides an electronic postmark confirmation that the return was filed on time. Also, E-filing is convenient, and it eliminates cumbersome paperwork.

When combined with direct deposit, a taxpayer's refund can arrive in as little as seven days. In 2015, the IRS reported that, of the more than 150 million individual returns filed, a ninety-one percent (91.0%) were E-filed, fulfilling an initial goal Congress set in 1998. The result is an automated system in which much of the labor burden is transferred to the taxpayer. The average individual refund was $2,797.00 for the 2015 Tax Season (2014 Tax Year) and accounted for a total refund amount of $306.0 billion. (Source: U.S. Taxpayers e-filed More Than 128 Million Returns in 2016: www.efile.com/efile-tax-return-direct-deposit-statistics/).

However, e-filing contributes to the complexity of the U.S. tax system, as the IRS demands ever more data for reporting of wage, interest and brokerage income with more tax forms. A discrepancy on a tax return may result in a rejection code, a letter from the IRS Automated Underreporting Unit, or a computerized audit out of a centralized IRS office in Ogden, Utah. There is minimal cost to the IRS for requesting extra information when it's received electronically.

Targeting taxpayers for audit seems to be a major factor behind the IRS's emphasis on e-filing. E-filed returns are available for audit several months sooner than paper returns, allowing more time before the three-year statute of limitations expires. The IRS has even boasted that its e-file database is “a rich and fertile field” for selecting audits and has estimated that if its “screeners could be reallocated to performing audits, they could bring in an additional $175 million annually” Source: E-filing and the Explosion in Tax-Return Fraud; author, Jay Starkman, via Wall Street Journal, 13 Jan. 2013).

2. Problems Related to IRS E-Filings

A) Typical problems with the U.S. E-Filing system were revealed in a recent CBS “60 Minutes” television segment in September 2014, Biggest IRS Scam Around: Identity Tax Refund fraud (ITRF). According to the “60 Minutes” segment, to collect an illegal tax refund, all that is needed is: a laptop (even a cell phone with the right electronic application will suffice); a taxpayer's Social Security Number (SSN) and date of birth; internet/wi-fi access; and a claim for a modest refund of a few thousand dollars. There is no need to provide supporting tax documents to substantiate the claim. Source: actual transcript of the “60 Minutes” segment. The thief then merely hits the “Send” button.

A scammer may indicate to the IRS that the refund should be mailed to his/her “house” (which is often a vacant home) and the arriving check can be cashed at unscrupulous businesses. Thieves also can have the refund wired to his/her bank account, or loaded onto a pre-paid debit card. Conventional credit-monitoring systems are apparently useless against ITRF.

B) The entire IRS system uses citizens' Social Security Account Numbers (SSAN, or “SSN”) as the primary means of identifying taxpayers. Those nine numbers are ubiquitous in private, public and corporate files and are a tempting object of theft. SSN's and date of birth information can be self-collected from several sources, including ancestry websites, bought on line from various sites; or bought from unscrupulous people working in institutions such as banks, hospitals, schools and universities, nursing homes, prisons, clinics, credit card companies, department stores, restaurants, accountants, doctor and dentist offices, etc.

C) There have been numerous studies and reports by the Departments of the IRS, Treasury, Justice, Government Accounting Office (GAO), congressional hearings and oversight committees, news media, etc. during the last several years regarding ITRF, which has been in existence since at least 2008. The practice has become even much more organized with reports of some criminals setting up “franchises”, teaching other people how to submit false returns for a cut of the “take.”

ITRF has escalated from hundreds of persons filling thousands of illegal returns to thousands of persons filing millions of illegal returns. During this time, ITRF cases have gone from 51,700 (in 2008) to IRS estimates of three million fraudulent refunds in 2012. (Source: CBS “60 Minutes,” September 2014). The U.S. Department of the Treasury believes the numbers are much higher. Identity theft cases are among the most complex and biggest challenges facing the IRS. The IRS has not yet come up with a way to stop this crime.

D) Not only are hard-working, conscientious taxpayers targeted for these scams, there are categories of individuals not normally required to file who are targeted, estimated at 15 million. (Source: the Internal Revenue Service and the Tax Foundation). These categories include: the deceased (thieves can get SSNs from a “Death Master File” published by the Social Security Administration and updated weekly!): residents of U.S. territorial possessions; students aged 16-20; children under the age of 14; the elderly; i.e. those with income below the required minimum for mandatory filing of a tax return.

E) A recent Treasury Inspector General for Tax Administration report (TIGTA) set forth categories for various types of individuals whose identities may have been stolen and used for fraudulent tax refunds. (Source TIGTA, Jul. 19, 2012). The total number of tax returns having the potential of being scammed amounted to 1,492,215 tax returns. From the following Table A, (produced by TIGTA), it can readily be seen that the deceased, elderly, citizens of U.S. possessions, students, young children and lower income individuals are potential identity theft targets. This is mainly because many of the persons in Table A don't have incomes, from whatever source, sufficient to meet the income requirements to file a federal tax return. It is worth noting that none of these individuals would be protected by the IRS's IP PIN (Identity Protection Personal Identity Number).

TABLE A
Analysis of Potentially Fraudulent Tax Refunds for TY 2010

| | Number of Tax | Refunds |
|---|---|---|
| Type of Individual | Returns | Issued |
| Deceased | 104,950 | $415,047,568 |
| Elderly | 76,338 | $374,419,730 |
| Citizens of U.S. Possessions | 67,789 | $387,183,428 |
| Students (ages 16 to 22) | 288,252 | $695,343,022 |
| Children (under age 14) | 2,274 | $3,960,327 |
| Income Level Does Not Require | 952,612 | $3,345,064,109 |
| Tax Return Filing [symbol] | | |
| Total | 1,492,215 | $5,221,018,184 |

Source: TIGTA analysis of TY 2010 tax returns. [symbol]
indicates data missing or illegible when filed

3. Problems Related to Filings of State Tax Returns

A) Tax fraud is a major problem for U.S. states also. Using TurboTax®, a 25-year-old woman e-filed a fraudulent 2011 Oregon return reporting wages of $3 million and claiming a $2.1 million refund—and amazingly, the Oregon Department of Revenue sent her the refund. (Source: E-Filing and the Explosion in Tax-Return Fraud: author, Jay Starkman; Wall Street Journal, Jan. 13, 2013). The State of Georgia reports that four percent (4.0%) of its returns are fraudulent. Florida, Georgia and the District of Columbia are the locations with the highest per-capita percentage of tax-related identity theft. (Source: Tax-Refund Fraud Soaring, Little the IRS Can Do: author, Matt Hunter@MattMHunter.ETCNBC.com, Feb. 11, 2015).

B) Intuit® Inc., based in Mountain View, Calif., is the largest online tax-software company in the U.S., with a reported 30 million customers. Recently, Intuit® temporarily halted electronic filing of all state tax returns after more than a dozen states spotted criminal attempts to obtain refunds through its systems. The company stated that its Turbotax® unit stopped transmitting state e-filing tax returns on 5 Feb. 2015 after seeing attempts to use stolen personal information to file fraudulent tax returns claiming refunds.

C) U.S. states are a potential gold mine for criminals, experts say, because with a single SSN a thief can file returns and collect refunds from coast to coast. “What's scary about the states is that they're not centralized,” (Source: Haywood Talcove, CEO of LexisNexis' Government and Special Services division, which is trying to market filtering services to the states. Because states generally do not share much tax information with one another, and because a taxpayer would not know if a fraudster had stolen their identity and filed in a distant state, the state version of this crime is much harder to detect.

D) Some states do recognize the problems with identity theft and fraudulent income tax returns. For example, on the front cover of Alabama's 2014 Form 40 Booklet for income tax forms and instructions, the following statements can be found:
“Identity theft is increasing at an alarming rate. One area that has seen a large increase is the filing of fraudulent income tax returns using stolen identities.”
“Another way to combat identity theft is to file your taxes electronically. E-filing is significantly more secure than paper filing. When you e-file, your return is processed predominately by computer. This means the fewest possibly chances of identity theft.”
“A paper return is handled by dozens of people—postage processing, letter opening, paper organizing, return scanning, the person who reviews and approves information and possibly many others. There are a lot of opportunities for identity theft with a paper return.”

Alabama does recognize the problem of identity theft and fraudulent income tax returns and the theme continues for 2015 with its “Taxpayer Identity Protection Program”. However, the state leans to the supposed “security” of e-filing but does not seem to acknowledge specific identity theft and income tax fraud at the e-file level as addressed by the present inventive concept.

4. Potential Remedies for Victims of ITRF

A) The IRS has assigned more than 3,000 of its employees to work on identity theft-related issues to prevent refund fraud and investigate identity theft-related claims. In addition, the IRS provides training to more than 35,000 employees who work with taxpayers to recognize identity theft indicators and help people victimized by identity theft. This does not include: the Law Enforcement Assistance Program (LEAP) with more than 300 state/local law enforcement agencies from 35 states participating: the Identity Theft Clearinghouse which develops and refers ITRF schemes to the Criminal Investigation Field Offices for investigation; and more than 30 multi-regional task forces or working groups including state/local and federal law enforcement agencies solely focusing on identity theft.

B) If a person becomes a tax-identity theft victim, the individual should immediately seek a referral to the IRS Identity Protection Specialized Unit or the Taxpayer Advocate Service using Form 911 and/or Form 14039, the Identity Theft Affidavit, which will help expedite the case if a fraudulent return is filed. The IRS has a backlog of 650,000 cases. According to a Nov. 7, 2013, report by the TIGTA, the IRS took an average of 312 frustrating days to resolve tax-related theft cases closed between August 2011 and July 2012. In addition, enforcement efforts are hampered by budget cuts. Legislation has recently passed by the House increasing penalties for tax refund fraud and the Senate Finance committee has scheduled more hearing . . . more laws and hearings but no solutions.

C) Bureaucracy seems to be a major problem. A suburban accountant met the police at her office after being alerted by the alarm company in December 2012. She discovered that a computer containing all of her clients' personal information, and prior years' tax returns had been stolen. The accountant, upon contacting the IRS identity theft unit, asked them to examine the returns being filed from her office and requested the IRS to flag the accounts of her clients that were listed in the theft report. The IRS refused, and further stated that nothing could be done until the false returns had been filed. (Source: Luke Gelber, May 2013, Citizens Against Government Waste; www.cagw.org/media/wastewatcher/tax-refund-fraud-and-identity-theft-)

D) Account identify fraud (financial, medical, legal, etc), credit card identity fraud; or any other document requiring a SSN and/or an account identifying number could be protected by a specific Anti-Fraud Identity Authentication Number (AFIN) 102, to be disclosed in detail below. The AFIN 102, based on a random alpha-numeric number generating software program, would be assigned and mailed each year to such “account holders.” The costs would be miniscule in comparison to the billions of dollars of credit card fraud reluctantly admitted to by credit card companies.

5. Prospective and Attempted IRS Fixes

A) The IRS has instituted an Identity Protection PIN (IP PIN), a unique six digit number that is assigned annually to victims of identity theft for use when filing their federal tax return, showing that a particular taxpayer is the rightful filer of the return. During the 2014 filing season, the IRS expected to provide more than 1.2 million victims, whose cases were resolved, with an IP PIN, which was up from more than 770,000 the year prior. The IP PIN will allow these individuals to avoid delays in filing returns and receiving refunds; however the IP PIN is only for victims with past resolved fraud cases, not all taxpayers.

B) Additionally, there is a limited pilot program, available only in the states of Florida and Georgia, and the District of Columbia. These locations have experienced the highest per-capita percentage of tax-related identity theft. (Source: Tax-Refund Fraud to hit $21 billion, and There's Little the IRS Can Do; by Matt Hunter (www.cnbc.com/2015/02/11/tax-refund-fraud-to-hit-21-billion). The pilot program is an expansion of the current IP PIN program, which generally has only been used for victims of identity theft. The PINs re only issued in December of each year.

C) Before a taxpayer can obtain an IP PIN, the IRS must ensure the filer is the correct taxpayer. This is done using a new web application where the taxpayer will be asked a series of questions only the taxpayer should be able to answer in order to verify their identity. The assumption is that all taxpayers have online capability and can negotiate the government forms and legalese, and that a database somewhere has all the relevant information. When filing electronically, failure to input the IP PIN for any taxpayer who has an IP PIN requirement will result in the electronic return being rejected. Once an IP PIN is received, it must be used on Forms 1040, 1040A, 1040EZ or 1040PR/SS whether filed electronically or by paper, to avoid being rejected or delayed. If filing a joint tax return on paper, only one IP PIN is required on the return, even if both spouses have separate ones.

D) If a citizen is filing electronically and does not use the IP PIN that has been issued, the return will reject and not be processed. If filed by paper, the return will be subjected to additional review to validate the filer's identity. This review will delay the processing of a tax return and the issuance of any refund that may be due. This increased validation is for the taxpayer's protection. For the purposes of this pilot program, the tax return is protected from identity theft only from the date the IRS assigned the IP PIN, and does not cover any actions related to the taxpayer's account prior to that date. The IRS is continually looking for additional ways to secure taxpayers' accounts and to combat identity theft.

E) The Internal Revenue Service is being urged, by the U.S. Government Accountability Office and the Treasury Department, to accelerate the due date of W-2 filing to January 31 and to lower an employer-company's threshold number (from 250 employees to only 5 or 10) for requiring electronic filing of W-2 returns in an effort to curb the growing trend of identity theft tax fraud.

F) ITRF takes advantage of the IRS's “look-back” compliance model. Rather than holding refunds until completing all of its compliance checks, foe IRS issues the tax refund only after conducting selected reviews of submitted tax returns.

G) The IRS currently cannot do such matching (comparing, or “cross-verifying” W-2's versus the actual tax return) when dealing because employers' wage data (from Form W-2 forms) are not available until months after the IRS issues most tax refunds. As a result, the IRS begins matching employer-reported W-2 data to tax returns in July, after the tax season. However, if the IRS had access to W-2 data earlier—through accelerated W-2 deadlines and increased electronic filing of W2 forms—it could conduct pre-refund matching and identity discrepancies to prevent the issuance of fraudulent refunds, according to the GAO report.

H) The Treasury Department proposed in 2014 that Congress accelerate W-2 deadlines to January 31. With the PATH Act (Protecting Americans from Tax Hikes) enacted in 2015, W-2 filing deadlines have finally been moved to January 31 of the year following the year to which such returns relate. This resulted in the requirement that 2016 W-2's be filed by Jan. 31, 2017. Such a change is consistent with the IRS's strategic plan, which calls for analytics-based decisions, and would help the IRS ensure effective use of resources, the GAO pointed out.

I) The Treasury Department has also requested authority to reduce the 250 minimum employer W-2 e-filing return threshold in order to have more W-2s available sooner form comparison against those returns that are e-filed. The IRS estimated that to meaningfully increase W-2 e-filing, the threshold would have to be lowered to include those companies filing only five to ten W-2 forms. This would allow the IRS to conduct more pre-refund matching. Without this change, some employers' paper W-2 forms could not be available for IRS matching until much later in the year, due to the additional time needed to process paper forms.

6. Financial Impact/Consequences

The GAO Report on identity Theft and Tax Fraud (IDT) of January 2015 for the filing season 2013 estimated total attempted identity theft refund fraud at $30 billion spread over a total of 5.1 million returns. Estimates of 2013 IDT refunds that were prevented or recovered totaled $24.2 billion covering 4.1 returns and $5.8 billion IDT refunds paid representing one million returns. The GAO Report on IDT for May 2016 for the filing season 2014 estimated total attempted identity theft refund fraud at $25.6 billion spread over a total of 4.9 million returns. Both GAO reports acknowledge that there was also undetectable IDT not discovered because of unknown schemes the IRS was not detecting. These statistics do not consider a like dollar amount that must eventually be paid to those taxpayers who were defrauded . . . for a total of $23.4 billion tax fraud related loss per year.

### BRIEF SUMMARY OP THE INVENTION

The purpose of this inventive concept is to empower U.S. and foreign state tax collecting authorities with the ability to substantially minimize a taxpayer's vulnerability to identity theft and tax refund fraud. This, in turn will reduce the billions of dollars paid out illegally to fraudsters each year. Embodiments of the present inventive concept provide a method and system for preventing income tax refund fraud by substantially eliminating the possibility of unauthorized use of the taxpayer's identity. A taxpayer's identify can be defined by the taxpayer's Social Security Number (SSN), or other governmental individual identification numbers (IIN), and personal information such as address, date of birth and other essential information.

In the preferred embodiment of the inventive concept, in coordination with a taxpayer's existing United States SSN, an Anti-Fraud Identity Authentication Number (AFIN) 102 is electronically generated, assigned, and issued each year to every U.S. citizen. The AFIN 102 is produced by a random alpha-numeric number generating software program, regardless of whether the citizen-owner of that SSN is required to file a tax return or not.

The AFIN 102 is mailed to each potential taxpayer by the U.S. Postal Service, thereby eliminating the possibility of electronic intercept. The AFIN 102 is designed to be applicable and used for federal as well as state and foreign income tax obligations and either paper or e-filed tax forms. The AFIN 102 is then included, in an electronic process of combining 104 with the taxpayer's SSN and other relevant personal information, as entered on the taxpayer's income tax form. This electronic process of combining 104 results in a designated identification term referred to as “AFIN/SSN” combination 104(a). The AFIN/SSN 104(a) is stored internally and securely by the IRS in a master AFIN/SSN Data Base 105, i.e. master file record.

The appropriate tax agency, whether the IRS of the United States, a U.S. state taxing authority, or a foreign tax agency, scans the submitted income tax returns electronically to compare the AFIN/SSN 104 combination submitted by the tax payer to a secure master AFIN/SSN 105 database master. If the scanned AFIN/SSN 104 combination on the return matches the master AFIN/SSN 105 database, the system automatically allows the transaction to complete, i.e. either tax payment or tax refund. If the scanned AFIN/SSN 104 combination on the return does not match the master AFIN/SSN 105 database, the return is subject to further tax agency scrutiny.

It is one thing for a criminal to fraudulently assume a taxpayer's identity i.e. Social Security Number (SSN), address, date of birth and the like, but it is very unlikely the criminal will also know the taxpayer's closely guarded AFIN 102 that is changed yearly and sent by mail where it is less likely to be intercepted, as compared to electronic transmission or stolen from various sources where it is not part of any electronic or paper field.

One objective of the present inventive concept provides for a method for generating a random alpha-numeric number, the Anti-Fraud Identity Authentication Number (AFIN 102), using software and equipment that is commercially available.

Another objective of the present inventive concept is to encompass all individuals holding a SSN in all fifty states, whether they are required to file income taxes or not.

An additional objective is to reduce complexity for taxpayers, by eliminating any requirement to go online (where scammers lurk), especially for those who are minimally computer literate.

Another objective of the present inventive concept is to free tax agency and law enforcement employees who now concentrate on identity tax refund fraud so that these human resources can be employed more effectively elsewhere.

A further objective of the present inventive concept is to eliminate the perceived need to move up W-2 filing deadlines or lower W-2 threshold numbers required for electronic filing by employers.

Still another objective of inventive concept is to substantially reduce the quantity of personal taxpayer information in private databases.

An additional objective of the present inventive concept is to eliminate long frustrating delays in resolving identity tax refund fraud matters.

In a further objective of the present inventive concept, is to eliminate the necessity for states to participate in the costly, time consuming sharing of taxpayer information with one another as a means to catch multi-state fraudsters.

Another objective of the inventive concept is to ensure that the dissemination of the AFIN breaks the cycle where criminals can obtain identifying information by online accessing IRS initiated, complimentary, supporting taxpayer self-help programs as seen in the past.

A further objective of the present inventive concept is to provide for a sealed mailer for the Anti-Fraud Identity Authentication Number (AFIN) and thereby significantly enhance its privacy and security. Even mail theft of the AFIN would probably be useless unless the thief also possessed knowledge of the owner's SSN and other personal information.

Yet, a further objective of the inventive concept is to provide a method for foreign countries which have social assistance programs similar to the U.S. Social Security Administration, to utilize individual identification numbers (IIN) associated with recipients of such a program(s), in combination with the Anti-Fraud Identity Authentication Number (AFIN) to help combat tax return fraud.

The major objective of the present inventive concept is to provide a means and system by which ITRF is prevented at the U.S. federal and state levels for a very small fraction of the cost of the billions of dollars lost annually through such fraud.

These embodiments, objectives and other features and advantages described herein will become more readily apparent and best understood by reference to the accompanying drawings and while read in conjunction with the following detailed description.

### BRIEF DESCRIPTION OF THE VIEWS OF THE DRAWINGS

FIG. 1 is a block flow diagram of method step 100, showing the major elements of the currently available, state of the art that is envisioned for the disclosed method, including showing the generation 101 of the Anti-Fraud Identity Authentication Number (AFIN) 102 with taxpayer personal information 103 to ultimately populate the master AFIN/SSN database 105.

FIG. 2 is a flow chart of method step 200 illustrating the generation, from the master AFIN/SSN database 105, a printed AFIN notice 202 which is sent to the taxpayer, who incorporates his/her AFIN 102 in their income tax forms 204 before sending them to the tax agency 205.

FIG. 3 is a block diagram of method step 300, further illustrating the procedural flow of the AFIN notice 203 sent to the taxpayer, and describing in general terms 301 its coordinated use with the taxpayer's income tax forms 204 prior to being sent to the tax agency 205.

FIG. 4 is a flow chart of method step 400 demonstrating an example of the prospective wording 401 of the mailing 203 of the AFIN notice 202 (not shown) as proposed by the present inventive concept.

FIG. 5 is a block schematic diagram of method step 500, showing the procedure by which a tax agency 205 would sequentially arrive at decisions supported by its authentication procedures comparing submitted income tax forms with the AFIN/SSN database 105.

FIG. 6 illustrates a partially-completed U.S. income tax form 600 showing only the inclusion of the taxpayers' names 601, address 602, Social Security Numbers 603 and AFINs 604, in accordance with the inventive concept.

### DETAILED DESCRIPTION OF THE INVENTIVE CONCEPT

The objects, features, and advantages of the inventive concept presented in this application are more readily understood when referring to the accompanying drawings. The drawings, totaling six figures, show the basic components and functions of embodiments and/or methods of use. In the several figures, like reference numbers are used in each figure to correspond to the same component as may be depicted in other figures.

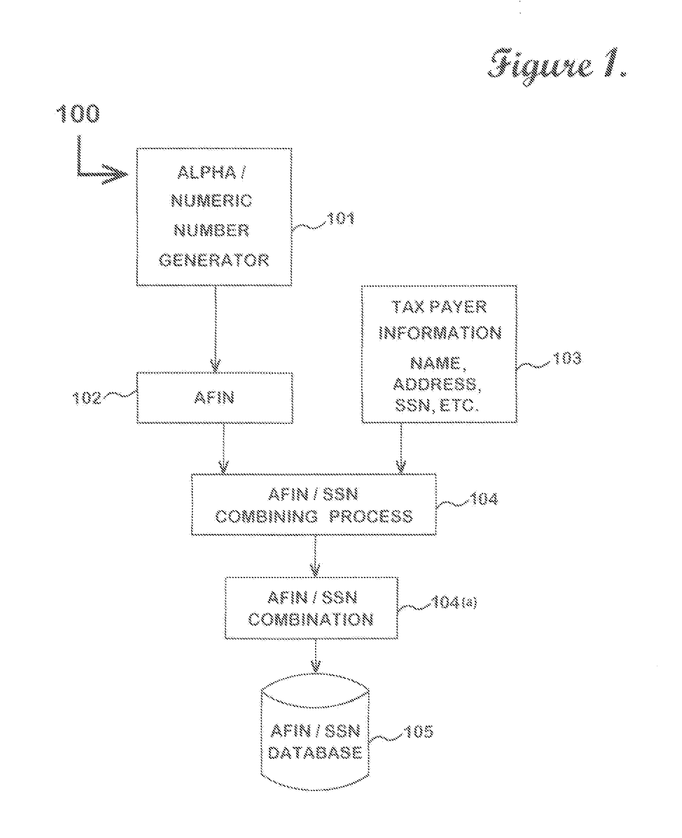

The inventive concept presented is designed as series of interconnected processes, or modules, comprising a total process. The steps of the several interconnected processes render the disclosed method workable in today's environment of ITRF. The discussion of the present inventive concept will be initiated with FIG. 1, which illustrates a functional diagram of method process 100 of the disclosed method and system. Illustrated are four basic modules: the Alpha/Numeric Number Generator 101; the resultant Anti-Fraud Identity Authentication Number (AFIN) 102; the Taxpayer Information 103 to include their Social Security Number (SSN); the AFIN/SSN combining process 104; and the AFIN/SSN Database 105. All of process 100 hardware, software, procedures, data process flow elements, etc. is known to those skilled in the present state of the art.

Each of the basic modules of process 100 interact to produce the AFIN/SSN database 105, which stores the taxpayer's AFIN/SSN Combiner 104 and other profile information such as date of birth, address, dependents and the like. The primary users of the method and system disclosed are the governmental taxing agency and the taxpayer.

Viewing FIG. 1 and referring to process 100 of the claimed inventive process, the Alpha/Numeric Number Generator 101 can be any generally recognized software program that has the capability to produce the Anti-Fraud Identity Authentication Number (AFIN) 102. Such software products can be part of database management systems offered by such generally recognized companies as, but not limited to, Computer Associates®, IBM®, Oracle®, Microsoft®, Sybase®, Teradata®0, i.e. known to those skilled in the present state of the art.

As shown in FIG. 1, the AFIN 102 of the present inventive concept can be an alpha-numeric or straight numeric number of any length, for example, twelve (12) digits and can be used by federal or state tax agencies. This is three digits more than a SSN and four less than most credit card numbers—none of which pose any problems for people to copy. If the alpha-numeric formulation is chosen, letters like “I”, “O”, “Q,” “U,” and “Z” should be disqualified from use to avoid confusion (during taxpayer printing on paper or electronic tax forms) with “one”, “zero”, “zero” “V,” or “2” respectively. In addition, the remaining twenty-one alphabet letters can be used in a twenty-one (21) year, revolving cycle before being used again. Not counting a letter prefix, with eleven numerical digits, mathematically there would be almost one hundred billion random federal AFIN 102 possibilities for each year.

For use by state tax agencies, the prefix letters can be each individual state's two letter state abbreviation such as AL for Alabama; CA for California; GA for Georgia; PA for Pennsylvania; TX for Texas and the like; followed by ten numerical digits would give almost ten billion random state AFIN possibilities. Likewise, if the disclosed method is used by foreign countries, the prefix letters may be the country's international two-letter code defined by the International Organization for Standardization (IOS).

The AFIN 102 is combined with taxpayer profile information, i.e. name, address, Social Security Number, etc. from existing databases 103. The AFIN/SSN Combiner 104 joins the AFIN 102 and SSN, along with other personal information, to produce the AFIN/SSN database 105. Typically, this operation would be performed within the realm of dedicated databases and database manager systems using Structured Query Language (SQL) which is available in successfully recognized products offered by companies such as Computer Associates®, IBM®, Oracle®, Microsoft®, Sybase®, Teradata®. Optimally, all these various resulting databases may be contained in one dedicated tax agency database server, i.e. one that is not accessible to the outside world.

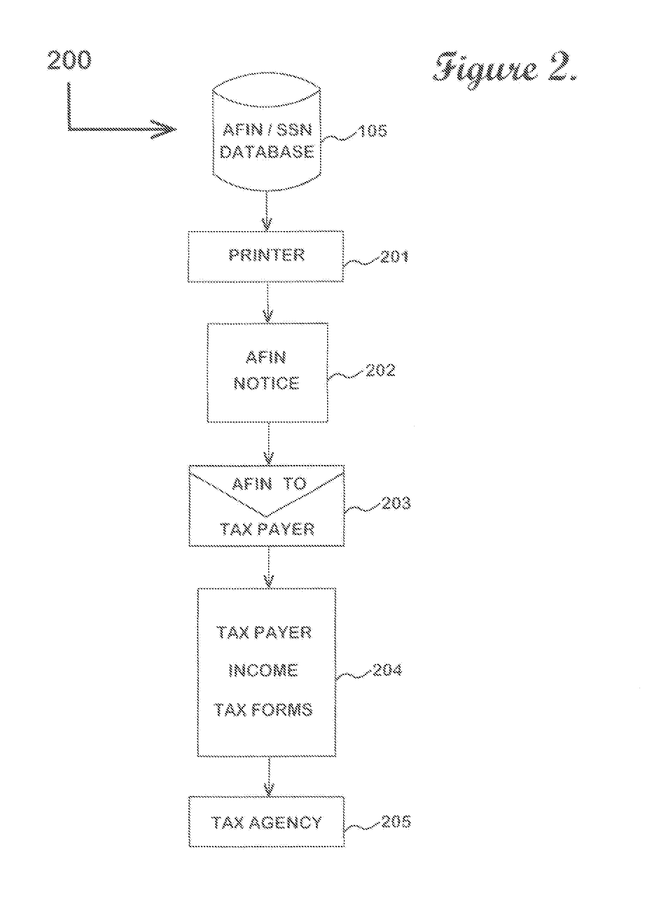

In reference to FIG. 2, the Process 200 of the present inventive concept compromises common AFIN/SSN Database 105; printer 201; AFIN Notice 202; AFIN 203 mailed taxpayer; Taxpayer Income Tax Form 204; and Tax Agency 205.

Referring to process 200 in FIG. 2 of the inventive concept, the AFIN/SSN database 105 is the feed for printers 201 to be utilized by the IRS in performance of the inventive concept. By means of coded instructions, the printers select the AFIN 102 and the taxpayer's name and address for coordinated printing. Printers with this capability and generally well known throughout the various U.S. federal governmental agencies.

The printers 201 receive computer-generated instructions to select the appropriate AFIN 102 and the corresponding taxpayer's name and address for printing. The AFIN notice 202 is then mailed 203 to each taxpayer. The Notice 202 can be as simple as a folded post card, with perforated seals on three edges which allow for easy opening similar, to other mailers commonly sent out by the Social Security Administration. Mailing the AFIN 102 number will protect the AFIN 102 from electronic intercept or by theft of information, particularly where similar such information is presently stored online.

Continuing with process 200, a taxpayer uses the AFIN 102 along with other pertinent information on his or her income tax forms 204 and sends the returns either as paper or electronic copies to the appropriate federal or state tax agency 205.

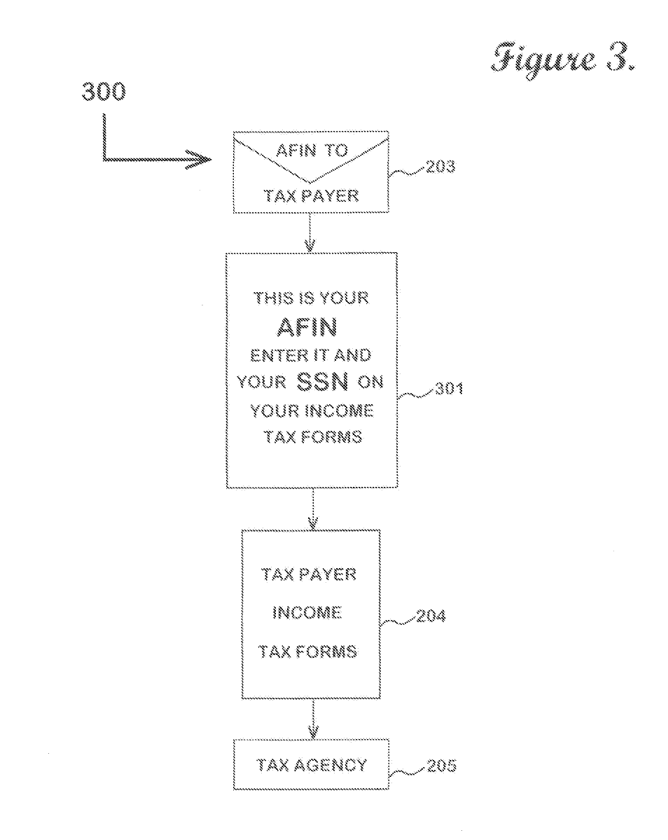

Referring to FIG. 3, the flow diagram of process 300, one embodiment of the present inventive concept illustrates the proposed standard of mailing 203 the AFIN mailed to a taxpayer. Shown in step 301 is a sample of clearly worded, simple AFIN instructional language. Step 204 schematically illustrates a grouping of taxpayer's income tax forms 204 which will be transmitted to the appropriate tax agency 205.

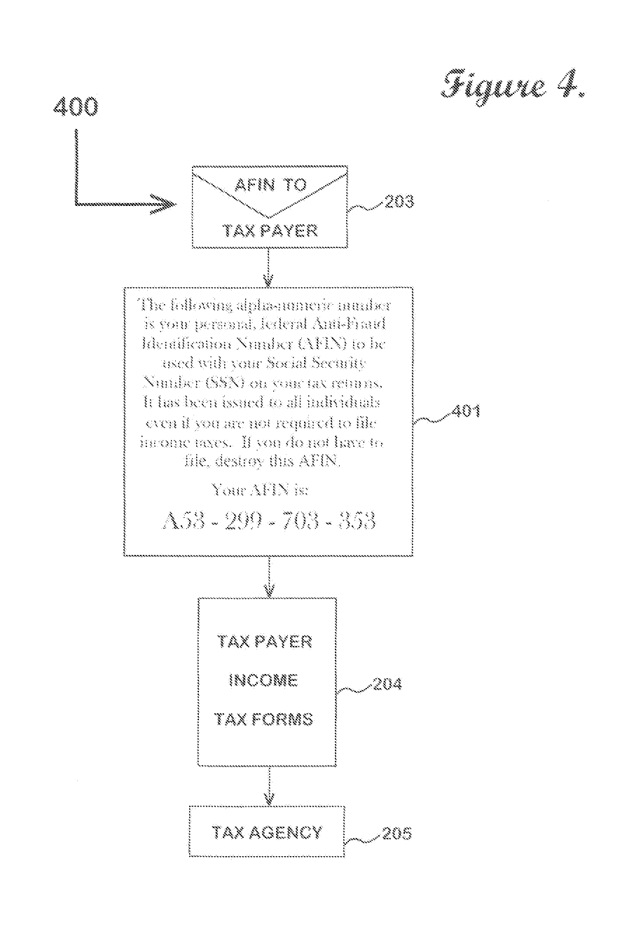

In FIG. 4, process 400 again illustrates the standard mailing 203 of the AFIN 102 (not shown) to a taxpayer. Also shown in FIG. 4 is a sample of an announcement 401 with informative language 401 which directs the taxpayer to the specific alpha-numerical sequence forming his/her AFIN 102. The taxpayer, assuming he/she is required to file an income tax return, then proceeds to submit the completed income tax forms to the appropriate tax agency 205.

More particularly, process 400 as detailed in FIG. 4 shows the AFIN Notice 203 mailed to the Taxpayer showing an example of specific AFIN instructional language 401 regarding the use of their AFIN in conjunction with their SSN on their Income Tax forms 204 which are sent to the necessary federal or state tax agency 205. The specific language in the example announcement states that the AFIN is to be used in conjunction with the taxpayer's SSN; that all individuals have been issued an AFIN even if they are not required to file income taxes; and that if the AFIN is not used to file income taxes, they are required to destroy it so that it is not used by unauthorized individuals.

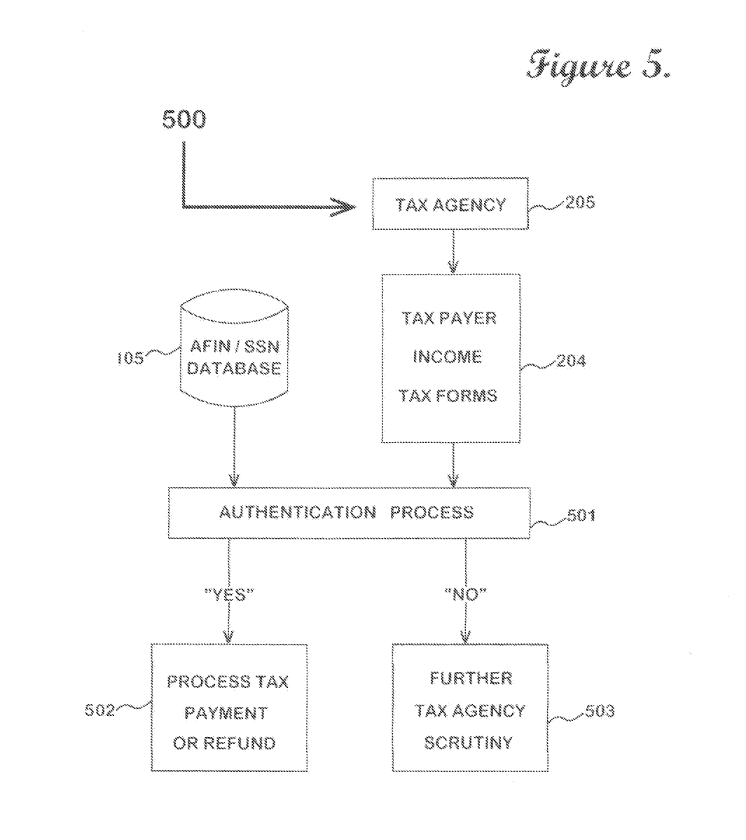

Referring to FIG. 5, the flow diagram Process 500 of the present inventive concept illustrates a typical tax agency 205, having received a taxpayer's income tax forms 204, and transmitting each individual tax form 204 to a computerized authentication process 501, in conjunction with information from the master AFIN/SSN database 105. As an example, the authentication process 501 may culminate in a “Yes” result, which is authentication to proceed with tax payment or refund payment 502. On the other hand, for a different submitted tax form 204, the authentication process 501 could render a showing of “No” or a rejection of the particular income tax form 204, indicating that further tax agency scrutiny 503 is required. Again, all hardware, software, procedures, data process flow, etc. is known to those skilled in the present state of the art.

With regard to process step 500, shown in FIG. 5, the tax agency 205 is in receipt of the taxpayer Income Tax Form 204. The taxpayer income tax form 204 is compared with the AFIN/SSN Database 105 by the authentication process 501 to verify that the return, taxpayer AFIN, SSN and all relevant information is correct and authentic. Currently, approximately ninety-one percent (±91.0%) of federal income tax forms 204 e-filed are submitted in an electronic file, which makes for a convenient comparison with the proposed AFIN/SSN Database 105.

The remaining ±9 percent of filed federal income tax forms are paper filed and must first be converted into electronic files to be compared with the AFIN/SSN Database 105. This can be done with large volume scanning/optical character recognition (OCR) equipment and software such as that offered by such generally recognized companies as, but not limited to, ABBYY USA®, C Vision Technology®, Cannon®, Fujitsu Computer Products®, Scan Corporation®, Prevalent Software® and the like.

In one embodiment, if the return is valid and the Process Transaction 502 shows a “YES” authentication, the income tax form 204 can proceed forward for either tax payment to the tax agency 205 or refund payment to the taxpayer. Alternatively, in another embodiment, if the Process Transaction 503 shows a “NO” authentication, the Income Tax Form 204 is subjected to further scrutiny by the Tax Agency 205.

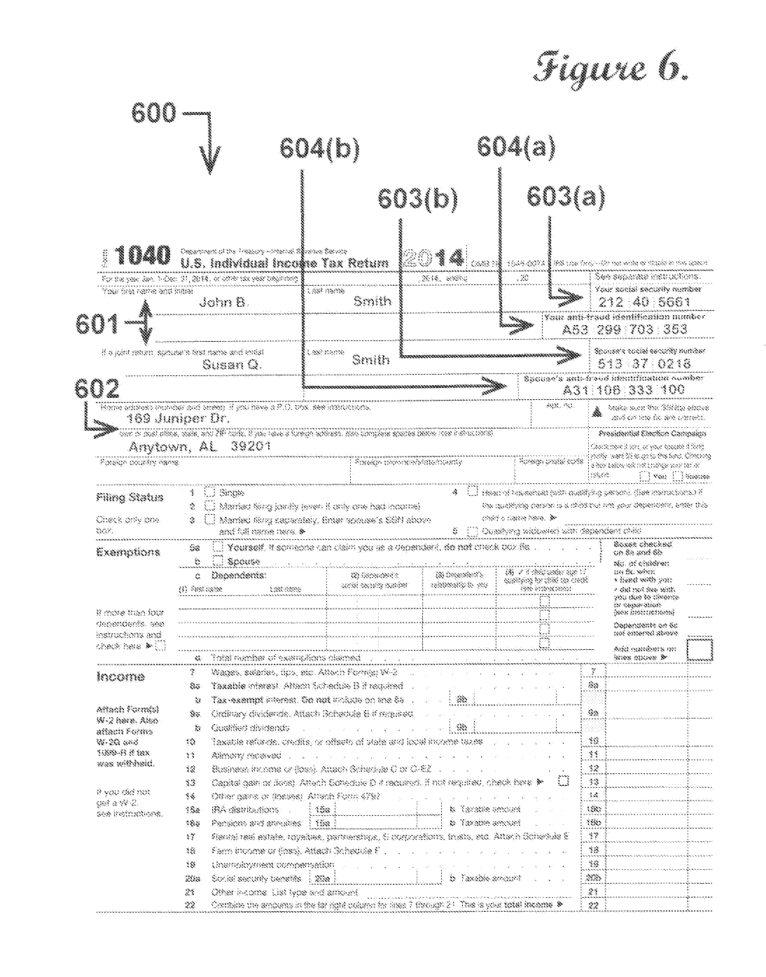

FIG. 6 illustrates an example of a partial 1040 income tax form 600 (referenced as “income tax form 204” in the preceding figures above). The hypothetical form 600 shows the location and inclusion of a fictional taxpayer's and spouse's names 601, address 602, SSNs 603(a), 603(b), and AFINs 604(a), 604(b) according to the present inventive concept.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and only limited by the scope of the claims presented herein.

What is claimed is:

1. In circumstances where a government entity maintains (a) at least one social program providing benefits relative to the welfare of its citizens through subsidies and/or assistance measures such as access to resources for food, housing, health care and well-being, including potentially vulnerable citizens such as children, the elderly, the unemployed, and where said citizens are assigned individual identification numbers (IIN), said INN being inclusive of personal information to thereby establish a citizen's identity and entitlement to said at least one social program, and (b) a tax agency or taxing authority, disclosed is a method for substantial elimination of the possibility of Identity Tax Refund Fraud (ITRF) relative to the tax agency of said government entity, the method comprising the steps of:
generating from a first software program, a plurality of random alpha-numeric identification numbers, said numbers designated as an “Anti-Fraud Identity Authentication Number” (AFIN);
obtaining, from an appropriate database, the individual identification number (IIN) and certain personal information of each of said citizens who are or may be beneficiaries of said at least one social action program;
combining, by a use of a second software program, a separate one of said AFIN's with the IIN of each of said citizens, thereby formulating a distinct designation entitled an “AFIN-IIN;”
compiling collectively, the totality of said AFIN-IIN's Into a Master AFIN-INN electronic database;
assigning and mailing, by domestic postal service, an individually distinctive AFIN to each of said citizens;
requiring that all citizens who submit tax returns to a tax agency or bureau of said government include their assigned AFIN with their tax return;
upon receipt by the fax agency of said tax returns from each one of said taxpayers, the tax agency scanning those of said tax returns received which have an AFIN included with said tax return;
said tax agency comparing whether each received tax return having as AFIN matches and corresponds to the AFIN-IIN stored within said Master AFIN-INN electronic database;
the tax agency continuing to process each of said tax returns received having matching AFIN-IIN information; or
the tax agency transferring those of the received tax returns having conflicting AFIN-IIN information for further scrutiny by the appropriate governmental department.

2. The method of claim 1 wherein the at least one social action program is at least one program maintained by the United States Social Security Administration, and wherein the tax agency is the United States Internal Revenue Service.

3. The method of claim 1, wherein the at least one social action program is that of the government of an individual American state selected from the group consisting of the fifty states of the United States of America, and wherein the tax agency is that operated by an American state, said state selected, in a co-related manner, from the group consisting of the fifty states of the United States of America.

4. The method of claim 1, wherein the citizen is a duly authorized and recognized business entity under the jurisdiction of said government.

5. The method of claim 1, wherein said Master AFIN-INN electronic database utilizes an internal, air-gapped secure data base, not connected to the world-wide web.

6. A method for substantial elimination of the possibility of Identity Tax Refund Fraud (ITRF), with respect to the Internal Revenue Service (IRS) of the United States, the method comprising the steps of:
generating, from a first software program, a plurality of random alpha-numeric identification numbers, each of said numbers designated as an “Anti-Fraud Identity Authentication Number” (AFIN):
obtaining, from an appropriate database, the individual social security numbers (SSN) and certain personal information of each of said living citizens who are or may be beneficiaries of any United States Social Security Administration program;
combining, by a use of a second software program, a separate one of said AFIN's with the SSN of each of said citizens, thereby formulating a distinct designation entitled an “AFIN-SSN;”
compiling collectively, the totality of said AFIN-SSN's into a Master AFIN-SSN electronic database:
assigning an individually distinctive AFIN to each of a plurality of prospective taxpayers;
mailing, via the United States Postal Service, all individually distinctive AFIN to each prospective taxpayer;
requiring that all persons who submit tax returns to the IRS include their AFIN with the return;
upon receipt by the IRS of each tax return, scanning those of said tax returns received which have an AFIN included with said tax return;
the IRS determining, by a scanning comparison, whether each received tax return listing an AFIN matches and corresponds with the AFIN-SSN stored within the Master AFIN-SSN electronic database;
the IRS continuing to process each of said tax returns received having matching AFIN-SSN information;
the IRS transferring those of the received tax returns having conflicting AFIN-SSN information for further scrutiny by the appropriate government department; and
the IRS re-assigning different AFIN to prospective taxpayers on an annual basis.

7. The method of claim 6, wherein the Internal Revenue Service is replaced by, and thereby comprises, a similar tax revenue bureau or agency of any single American state, said state selected from the group consisting of the fifty states of the United States of America.

8. The method of claim 6, wherein (a) the prospective taxpayer is a duly authorized and recognized business entity, (b) the SSN is replaced by the Employer Identification Number (EIN) of said business entity, and (c) there is complied a Master AFIN-EIN electronic database.

9. The method of claim 6, wherein said Master AFIN-SNN electronic database utilizes an internal, air-gapped secure data base, not connected to the world-wide web.

10. A method for reducing complexity by means of eliminating any requirement for a taxpayer to go online via the internet for acquiring a tax-related Personal Identification Number (PIN), the method comprising, the steps of:
generating, from a first software program, a plurality of random alpha-numeric identification numbers, each of said numbers designated as an “Anti-Fraud Identity Authentication Number” (AFIN);
obtaining, from an appropriate database, the individual social security numbers (SSN) and certain personal information of each of said living citizens who are or may be beneficiaries of any United States Social Security Administration program;
combining, by a use of a second software program, a separate one of said AFIN's with the SSN of each of said citizens, thereby formulating a distinct designation entitled an “AFIN-SSN;”
compiling collectively, the totality of said AFIN-SSN's into a Master AFIN-SSN electronic database;
assigning an individually distinctive AFIN to each prospective United States taxpayer;
mailing, via the United States Postal Service, an individually distinctive AFIN to each prospective taxpayer; and
requiring that all persons who submit tax returns to the IRS include their AFIN with the return.

11. A method for freeing tens of thousands of United States Federal and State tax agency and law enforcement employees who currently have duties involving combatting Identity Tax Refund Fraud (ITRF) so that these human resources can be employed more effectively elsewhere, the method comprising the steps of:
generating, from a first software program, a plurality of random alpha-numeric identification numbers, each of said numbers designated as an “Anti-Fraud Identity Authentication Number” (AFIN);
obtaining, from an appropriate database, the individual social security numbers (SSN) and certain personal information of each of said living citizens who are or may be beneficiaries of any United States Social Security Administration program;
combining, by a use of a second software program, a separate one of said AFIN's with the SSN of each of said citizens, thereby formulating a distinct designation entitled an “AFIN-SSN;”
compiling collectively, the totality of said AFIN-SSN into a Master AFIN-SSN electronic database;
assigning an individually distinctive AFIN to each of prospective taxpayers;
mailing, via the United States Postal Service, an individually distinctive AFIN to each prospective taxpayer;
requiring that all persons who submit tax returns to the IRS include their AFIN with the return;
upon receipt by the IRS of each tax return, scanning those of said tax returns received which have an AFIN included with said tax return;
the IRS determining, by a scanning comparison, whether each received tax return listing an AFIN matches and corresponds with the AFIN-SSN stored within the Master AFIN_SSN electronic database;
the IRS continuing to process each of said tax returns received having matching AFIN-SSN information;
the IRS transferring those of the received tax returns having conflicting AFIN-SSN information for further scrutiny by the appropriate government department; and
the IRS re-assigning different AFIN to prospective taxpayers on an annual basis.

12. An improved method for combating Identity Tax Refund Fraud (ITRF) with respect to the U.S. Internal Revenue Service, the improvement comprising:
generating, from a first software program, a plurality of random alpha-numeric identification numbers, each of said numbers designated as an “Anti-Fraud Identity Authentication Number” (AFIN);
obtaining, from an appropriate database, the individual social security numbers (SSN) and certain personal information of each of said living citizens who are or may be beneficiaries of any United States Social Security Administration program;
combining, by a use of a second software program, a separate one of said AFIN's with the SSN of each of said citizens, thereby formulating a distinct designation entitled an “AFIN-SSN;”
compiling, collectively, the totality of said AFIN-SSN's into a Master AFIN-SSN electronic database;
assigning an individually distinctive AFIN to each of prospective taxpayers;
mailing, via the United States Postal Service, an individually distinctive AFIN to each prospective taxpayer;
requiring that all persons who submit tax returns to the IRS include their AFIN with the return;
upon receipt by the IRS of each tax return, scanning those of said tax returns received which have an AFIN included with said tax return;
the IRS determining, by a scanning comparison, whether each received tax return listing an AFIN matches and corresponds with the AFIN-SSN stored within the Master AFIN-SSN electronic database;
the IRS continuing to process each of said tax returns received having matching AFIN-SSN information;
the IRS transferring those of the received tax returns having conflicting AFIN-SSN information for further scrutiny by the appropriate government department; and
the IRS re-assigning a different AFIN to prospective taxpayers on an annual basis.

13. The improved method of claim 12, wherein said Internal Revenue Service is replaced by, and thereby comprises, a similar tax revenue bureau or agency of any single American state, said state selected from the group consisting of the fifty states of the United States of America.

14. The method of claim 12, wherein (a) the prospective taxpayer is a duly authorized and recognized business entity subject to filing a business tax return; (b) the SSN is replaced by, the said business entity Employer Identification Number (EIN) of said business entity, and (c) there is compiled a Master AFIN-EIN electronic database.

15. The method of claim 12, wherein said Master AFIN-SSN electronic database utilizes an internal, air-gapped secure data base, not connected to the world-wide web.

16. The method of any one of claims 6, 10, 11, or 12, wherein the prospective taxpayer confirms, by U.S. Postal System mail, the receipt of his/her assigned AFIN.
